(19) United States
(12) Patent Application Publication
(10) Pub. No.: US 2011/0246469 A1
(43) Pub. Date: Oct. 6, 2011

(54) TECHNIQUES TO CAPTURE CONTEXT AND LOCATION INFORMATION AND UTILIZE HEURISTICS TO TURN LOCATION TRACKED OVER TIME AND CONTEXT INFORMATION INTO SEMANTIC LOCATION INFORMATION

(76) Inventors: Mark D. Yarvis, Portland, OR (US); Rita H. Wouhaybi, Portland, OR (US); Philip Muse, Folsom, CA (US); Lenitra M. Durham, Beaverton, OR (US); Sai P. Balasundaram, Beaverton, OR (US); Sangita Sharma, Portland, OR (US); Chieh-Yih Wan, Beaverton, OR (US)

(21) Appl. No.: 13/161,990

(22) Filed: Jun. 16, 2011

Related U.S. Application Data
(62) Division of application No. 13/130,203.

(51) Int. Cl. G06F 17/30

(52) U.S. Cl. 707/740; 707/756; 707/E17.009

(57) ABSTRACT

An embodiment of the present invention provides a method, comprising capturing context information of a user and using heuristics based on a common knowledge database to turn location tracked over time combined with the context information into semantic location information. Embodiments of the present invention may further provide creating and identifying said heuristics and wherein trace data of GPS coordinates are obtained continuously throughout the user's day and first clustered to identify interesting locations, then up-leveled to a street address or business name and then semantically interpreted in one of several categories.

### CROSS REFERENCE TO RELATED APPLICATIONS

The present application is a divisional application of U.S. patent application Ser. No. 13/130,203, filed 19 May 2011, entitled, “CONTEXT INFORMATION UTLIZING SYSTEMS, APPARATUS AND METHODS”, by Yarvis et al; which was a U.S. national stage patent application of PCT patent application serial number PCT/US2009/068131, filed 15 Dec. 2009, entitled, “CONTEXT INFORMATION UTLIZING SYSTEMS, APPARATUS AND METHODS”, by Yarvis et al.

### BACKGROUND

The rapid development of wireless devices and their ever-improving capabilities have enabled users to communicate and obtain vast information while being highly mobile. Users of such devices are increasingly able to capture contextual information about their environment, their interactions, and themselves on various platforms. These platforms include, but are not limited to, mobile computing/communication devices (e.g., PDAs, phones, MIDs), fixed and portable computing devices (laptops and desktops), and cloud computing services and platforms. Both raw context and profiles derived from this context have a potentially high value to the user, if the user can properly manage and share this information with service providers. Service providers may use this information to better tailor offers to the user, to better understand their customers, or to repackage and sell (or otherwise monetize).

The user potentially stands to benefit through a better service experience or through a specific incentive. The user's ability to leverage this context is currently limited in the following ways: there is no automated way to share, combine, or integrate context across platforms owned by the same user; there is no automated and/or standardized way for the user to share this context with service providers, with or without compensation; and there is no simple mechanism for controlling access to context.

Location information, such as GPS coordinates, a street address, or store name, are useful for navigation. For other applications, semantic location labels, such as “my home,” “my friend's home,” “my office,” “my gym,” may be more appropriate.

While shopping online, users typically interact with a web based interface, browsing through product lists and performing searches. Searches can be for a combination of product category, brand name, or specific product identifiers (e.g., model numbers). Both the searches themselves and the pages viewed (both the sites viewed and the contents of the specific pages) provide clues about the user's in-market interests for products.

Thus, a strong need exists for systems, apparatus and methods that are capable of gathering, accumulating, manipulating, managing and utilizing context information.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 depicts building blocks of embodiments of the present invention;

FIG. 2 shows clustering and mapping according to embodiments of the present invention;

FIG. 3 shows identification and up-leveling according to embodiments of the present invention; and

FIG. 4 shows a product with specification and browsing/shopping information/history found by a user according to embodiments of the present invention.

It will be appreciated that for simplicity and clarity of illustration, elements illustrated in the figures have not necessarily been drawn to scale. For example, the dimensions of some of the elements are exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the preset invention may be practiced without these specific details. In other instances, well-known methods, procedures, components and circuits have not been described in detail so as not to obscure the present invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. For example, “a plurality of stations” may include two or more stations.

As mentioned above, users are increasingly capable of capturing contextual information about their environment, their interactions, and themselves on various platforms. These platforms may include, but are not limited to, mobile computing/communication devices (e.g., PDAs, phones, MIDs), fixed and portable computing devices (laptops and desktops), and cloud computing services and platforms. Both raw context and profiles derived from this context have a potentially high value to the user, if the user can properly manage and share this information with service providers. Further, embodiments of systems of the present invention may provide a platform that is an information assimilation and communication platform.

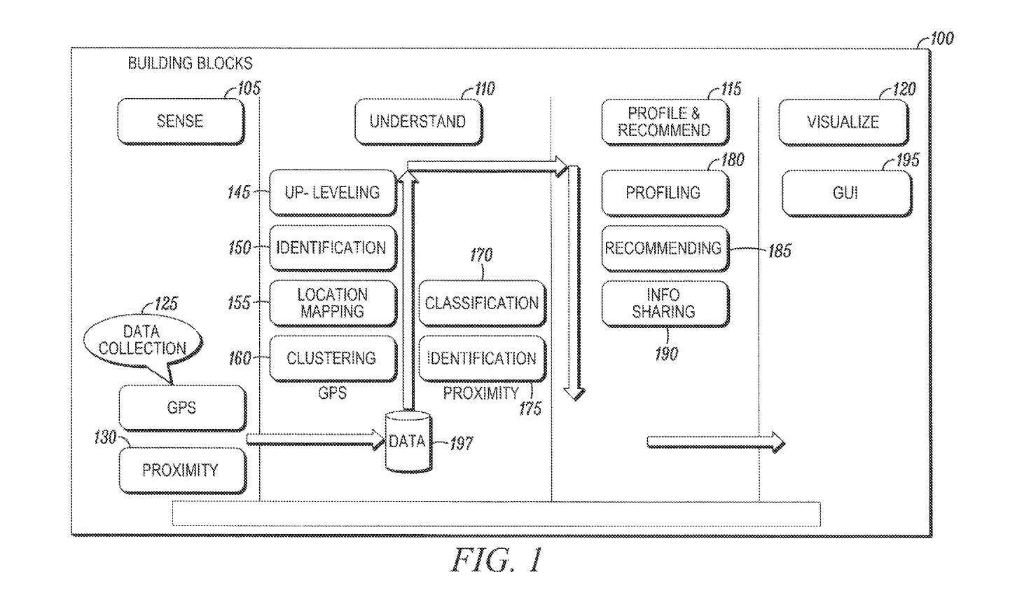

Embodiments of the present invention may utilize heuristics based on a common knowledge database to turn location tracked over time combined with other pieces of simple context, such as day of week and time of day, into semantic location with the basic building blocks of this shown as 100 of FIG. 1, which illustrates the following building blocks: sense 105, understand 110, profile and recommend 115 and visualize 120. Shown included in the sense block 105 is GPS data collection 125 and proximity information 130 fed to data 197. In the understand block 110 is included up-leveling 145, identification 150, location mapping 155 and clustering 160 as well as classification 170 and identification 175. Profiling 180, recommending 185 and info sharing 190 are included with profile and recommend block 115. GUI 195 is exemplified in visualize block 120.

For example, if a person's GPS location 125 tells us that they are in the same general location almost every day from midnight until sometime in the morning, we can assume that this location is home. In many cases, such assumptions cannot be easily obtained and/or verified using public data, however, human knowledge tells us that they are correct with a high probability.

Embodiments of the present invention provide creating an interface where these heuristics can be created and identified. Trace data of GPS coordinates 125 obtained continuously throughout the user's day may be first clustered 160 to represent one general location, then location mapped 155 to identify interesting locations, identified further using public information and human knowledge 150 and up-leveled 145 to a street address or business name, then semantically interpreted (understood 110) in one of several categories or classifications 170 (home, work, shopping, entertainment, transit, etc) and in conjunction with proximity identification 175 (e.g., who is nearby? family members, coworkers, etc). This last step involved heuristics, such as (1) if the user spends most evenings at the same location then it's probably home, (2) if the user spends the bulk of working hours at a location that's probably work, (3) if the user is at a restaurant with coworkers that's probably a business meal, (4) if the user is at an airport with family members that's probably a vacation. This is an important step because mappings from sets of GPS coordinates 125 to business name/address lead to many false positives and negatives. The results of this mapping can be further refined into a set of daily patterns. Thus, embodiments of the present invention determine typical user patterns and interests, current activities and goals, life events, and specific opportunities to provide recommendations or market products. Patterns might include when and how often the user likes to shop, what kinds of stores they go to, where they prefer to eat, what they do for fun, how often they exercise, and other similar human interests. Life events may include marriage, a new baby, a vacation, purchasing a new home, or other major life activities. These patterns and life events can often be ascertained by where a user goes over the course of one or more days, and what other people are with them.

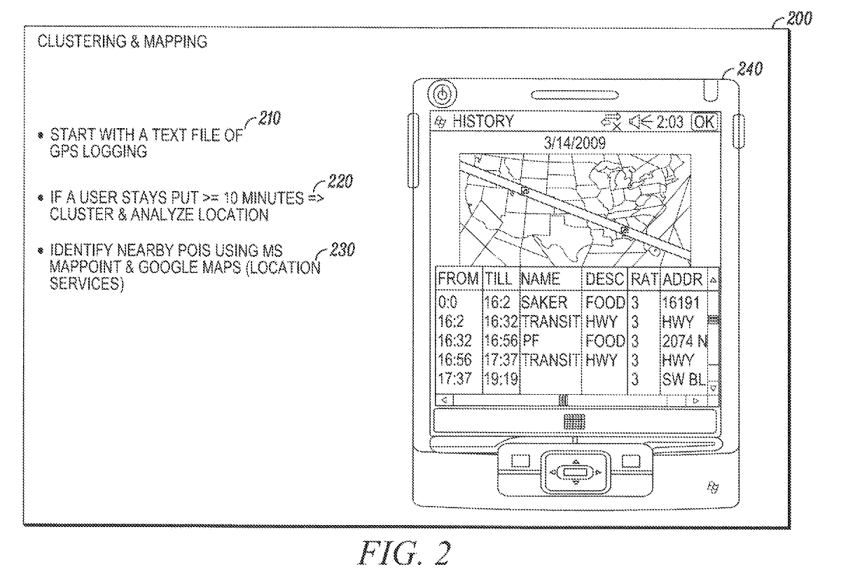

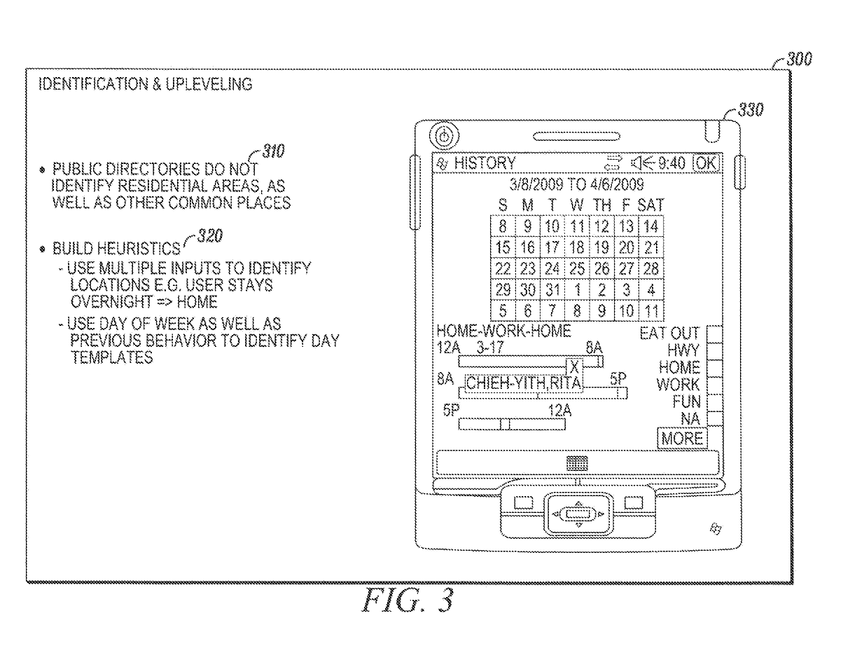

Over time a mobile device may track, perhaps via GPS, the locations visited by a user as shown generally as 200 of FIGS. 2 and 300 of FIG. 3. FIG. 2 illustrates the clustering and mapping of embodiments of the present invention and includes starting with a text file of GPS logging 210; if a user stays put (e.g., greater than 10 minutes within a perimeter of a location), then cluster and analyze location 220; and at 230 identify nearby positions using location services, such as, but not limited to, Microsoft® MapPoint® or Google Maps®. An example smart phone or PDA or the like is generally shown at 240 and not intended to limit the present invention to any particular information assimilation and communication device.

FIG. 3 at 300 generally shows the identification and up-leveling of the user's day in embodiments of the present invention and may utilize public directories, which do not identify residential areas, as well as other common places. At 320 build heuristics which may use multiple inputs to identify locations (e.g., user stays overnight then likely user is at home) as well as use of day of week, previous behavior, calendar information, or even user's input and feedback to identify day templates—again these are just examples of data that may be considered in building heuristics. At 330, again is an example smart phone or PDA or the like and not intended to limit the present invention to any particular information assimilation and communication device. As shown, each day of the month may be broken down into segments of time that the user spent doing specific high-level activities, such as eating out, traveling (hwy), at home, at work, or having fun.

Knowing the general shopping preferences and habits of users are key pieces of information for targeted advertising. Embodiments herein may utilize web browsing behavior to determine the products the current user is interested in purchasing and how they typically like to shop.

As mentioned above, while shopping online, users typically interact with a web based interface, browsing through product lists and performing searches. Searches can be for a combination of product category, brand name, or specific product identifiers (e.g., model numbers). Both the searches themselves and the pages viewed (both the sites viewed and the contents of the specific pages) provide clues about the user's in-market interests for products. For example, if the user searches for a specific product model number on several merchant sites in a short period of time, that likely indicates product interest. If the user subsequently searches for a different model in the same category, that may indicate an interest in the product category, rather than the specific product itself (thus we may up-level our notion of the user's interest from the specific product to the broader category). If the user searches for the product category and brand name, this may indicate a brand preference. If the user places items in his e-basket at several sites, perhaps to check pricing and shipping costs, the user may be very close to making a purchase. The above examples can be extended to identify several characteristics of a shopper: what kinds of products the shopper typically purchases (e.g., clothes or electronics), brand loyalty, merchant loyalty (what sites does the user actually purchase from), impulsiveness (how much research and time is required prior to purchase), and frugality (is the lowest cost option, including shipping, always chosen?).

Although not limited in this respect, embodiments of the present may be incorporated with an Internet browser, such as a plug-in for FireFox®. In this embodiment, the extension watches all web pages loaded and analyzes the URL, page text, and cookies associated with each loaded web page.

It also may analyze individual pages to determine if they represent a search result or a product web page, based on known web page patterns. Searchers can be identified at a variety of merchant sites (mentioned below), plus google.com, shopper.com, Wikipedia.com, and yahoo.com. The system leverages known URL formats and page structure and textual patterns. The system keeps track of the number of times a search has been executed and the set of sites on which the search was executed.

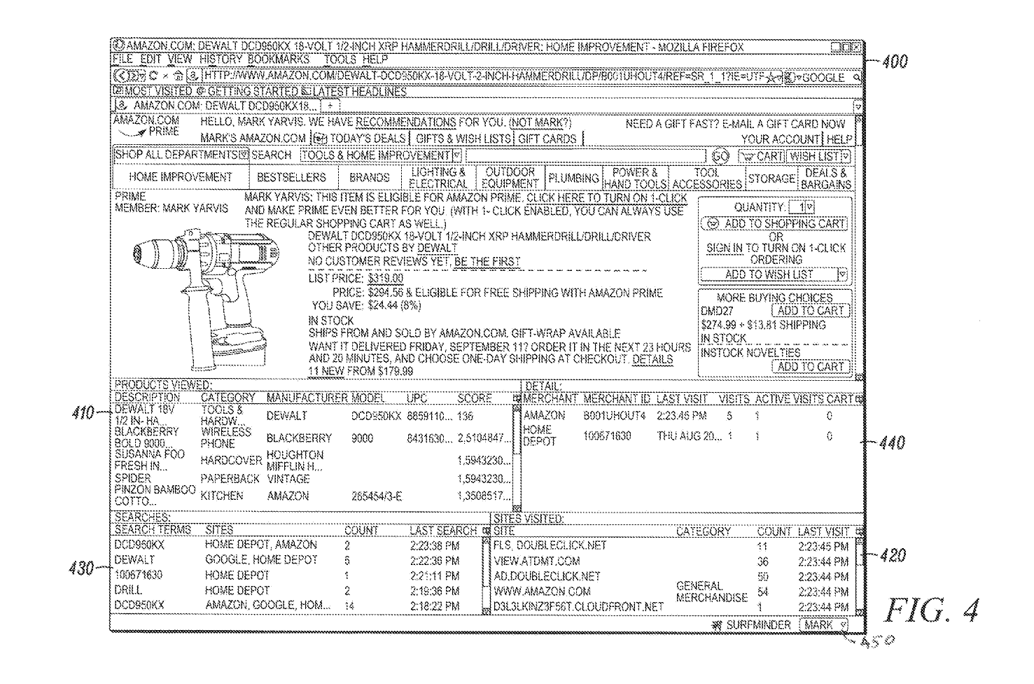

Embodiments of the present invention may identify product views on merchant sites such as Amazon.com, homedepot.com, bedbathandbeyond.com, bestbuy.com, google.com, and target.com, although the present invention is not limited in this respect. Product details (shown generally as 400 of FIG. 4) can be gleaned from the web pages (using known URL formats and page structure and textual patterns), and additional information can be obtained from public web services engines, such as the Amazon Web Service and a similar BestBuy database, which contain detailed descriptions, identifiers, and categorical information for a large number of products available for sale. While the user browses product information via the typical web interface, illustrated as 400 of FIG. 4, the system may track the set of products the user has viewed over time 410. For each product, the system may track key information such as a product description, category, manufacturer, model number, ad UPC code, to allow multiple views of the same product to be correlated. The system may guess that two products are the same if a majority of available information about the product matches this record. For each product record, the system may maintain a list of sites on which the user viewed the product 440, including the merchant's identifier for the product, the date of last view at this merchant, the total number of views of this product at this merchant, the number of times the user actively interacted with the product web page (clicking on the page or scrolling through the page), and the number of times the product was placed in a virtual cart. The system may track specific searches the user has performed 430, including the sites where this search was performed (both merchants and web search sites), the number of searches performed, and the date of the last search. The system may also track the list of all sites visited, including the number of visits and date of last visit for each site. In addition, the system can identify user credentials from web pages and cookies, and can thus attribute searches and product views to a specific user 450. Identification of the current user can occur at startup time, by examining cookies representing active logins to web sites, or interactively, by watching as the user is authenticated to specific web pages.

By tracking the above information, the system can try to guess or calculate or otherwise determine which products the user is actively interested in purchasing. In this embodiment, this is accomplished by scoring each product according to the following formula:

$$score = {A}^{d} ( {W}_{p} {V}_{p} + {W}_{a} {V}_{a} + {W}_{M} ( M - 1 ) + {W}_{C} C + {\sum }_{searchs} {W}_{S} {S}_{i} )$$

### Where

A is an aging factor (e.g., 0.9)

d is the number of days since the last view of this product

Vₚ is the number of total page views for this product over all merchants

Wₚ is the numerical weighting for page views

Vₐ is the number of active page views of this product over all merchants

Wₐ is the numerical weighting for active page views

M is the number of merchants at which this product was viewed

W_{M} is the numerical weighting for the merchant count

C is the number of times the product was placed in a cart over all merchants

W_{C} is the numerical weighting for product cart additions

Sᵢ is the number of terms in the ith search that matched metadata for this product.

W_{S} is the numerical weighting for metadata matches

Each products score is shown at 410. Since the list is sorted in descending order by score, the top products are predicted to be currently of most interest to the user.

The system can also use the collected information to determine what categories of products the user typically shops for and the set of merchants frequented. The system may also determine the user's typical shopping patterns, for example, how long (in terms of time and number of information sources consulted) the user shops before they make a purchase. All of the above information can be used to drive recommendations in the form of offers related to relevant products, product categories, or merchants.

As described above, a user's personal devices identify in-market purchasing interests. These interests may represent user goals. In some cases, these goals may have a timeline. For example, a gift must be purchased prior to a loved one's birthday. In other cases, the timeline may be open ended. While the goal is active, it is part of the user's profile, and recommendations may be made in an effort to help the user satisfy the goal. The act of purchasing the item may represent the satisfaction of the goal, reducing the user's interest in receiving further recommendations toward that goal. However, other goals may be derived as a result. For example: Buy another gift next year. In the fall, remember to get those new skis waxed. Renew your warrantee next year. Embodiments of the present invention provide that these goals may be added to a user's profile to trigger additional recommendations. Goal satisfaction can be identified via a variety of contextual inputs: location (noting that you traveled to the destination of a specific errand), traces from online shopping activity, credit card bills, a pay-by-phone transaction (payment initiated by the phone device, with ultimate payment made via phone bill, as an example and not by way of limitation).

Embodiments of the present invention provide activity breakdown into sub activities, which may be very useful in creating recommendations since part of an activity might have been enjoyed while other parts dreaded. Rating of the entire activity will not easily reflect these nuances. Identifying these different sub-activities may be performed through the use of different types of sensors and their derived context. Then a series of these will be created and rated according to the state of the user during each of these activities. For example, a user goes to the movie theatre; with no activity breakdown they might rate their experience with 3 stars. However, we can break the activity into the different parts, i.e. parking in the theatre parking lots, buying the ticket from the box office, purchasing some popcorn and refreshments from the food stand, walking into the theatre, watching the movie, and possibly using the restrooms. As a result, each of these sub-activities will get a different rating and accordingly, future recommendations might involve a different theatre if the lines were too long for the food, and the parking lot too crowded and not well lit, at the same time, a movie by the same director might get a better chance of being recommended if the user enjoyed the movie itself. Since each sub-activity has its own context, rating will influence that context without affecting negatively or positively the other context.

Embodiments of the present invention may identify goals based on user activity or other context. While we could attribute all such goals to the user (the device owner), users often perform tasks related to others (e.g., going shopping with a friend, purchasing a gift, running an errand for someone). Thus attributing everything to the user's interests and profiles pollutes the user's profile. Instead, embodiments of the present invention may use contextual clues to determine when a goal is related to the user or someone else. For example, if a man goes into a perfume store a few days before his anniversary, we might conclude that he is in-market for a gift for his wife. If a man is in a women's clothes store with his girlfriend, we might conclude that he is keeping her company, rather than shopping. The result is a profile that is segmented. The primary segment relates to the user directly. Other segments relate to other people or activities related to the user.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

We claim:

1. A method, comprising:
capturing context information of a user and using heuristics based on a common knowledge database to turn location tracked over time combined with said context information into semantic location information.

2. The method of claim 1, further comprising creating and identifying said heuristics.

3. The method of claim 2, wherein trace data of GPS coordinates are obtained continuously throughout said user's day and first clustered to identify interesting locations, then up-leveled to a street address or business name and then semantically interpreted in one of several categories.

4. The method of claim 3, wherein said heuristics are used to semantically interpret said clustered locations upleveled to a street address or business name, into one of several categories.

5. The method of claim 4, further comprising further refining categories into a set of daily patterns.

6. The method of claim 1, further comprising distributing said semantic location information to a service provider, wherein said service provider provides an incentive to said user for said context information.

7. A computer readable medium encoded with computer executable instructions, which when accessed, cause a machine to perform operations comprising:
capturing context information of a user and using heuristics based on a common knowledge database to turn location tracked over time combined with said context information into semantic location information.

8. The computer readable medium of claim 7, further comprising additional instructions causing said machine to perform further operations including creating and identifying said heuristics.

9. The computer readable medium of claim 8, wherein trace data of GPS coordinates are obtained continuously throughout said user's day and first clustered to identify interesting locations, then up-leveled to a street address or business name and then semantically interpreted in one of several categories.

10. The computer readable medium of claim 9, wherein said heurists are used to semantically interpret said clustered locations upleveled to a street address or business name, into one of several categories.

11. The computer readable medium of claim 10, further comprising additional instructions causing said machine to perform further operations including further refining categories into a set of daily patterns.

12. The computer readable medium of claim 7, further comprising additional instructions causing said machine to perform further operations further comprising distributing said semantic location information to a service provider, wherein said service provider provides an incentive to said user for said context information.

13. A system, comprising:
an information assimilation and communication platform adapted to capture context information of a user and use heuristics based on a common knowledge database to turn location tracked over time combined with said context information into semantic location information.

14. The system of claim 13, wherein said platform creates and identifies said heuristics.

15. The system of claim 14, wherein trace data of GPS coordinates are obtained continuously throughout said user's day and first clustered to identify interesting locations, then up-leveled to a street address or business name and then semantically interpreted in one of several categories.

16. The system of claim 15, wherein said heurists are used to semantically interpret said clustered locations upleveled to a street address or business name, into one of several categories.

17. The system of claim 16, wherein said platform further refines categories into a set of daily patterns.

18. The system of claim 13, wherein said platform is capable of distributing said semantic location information to a service provider, wherein said service provider provides an incentive to said user for said context information.

19. An apparatus, comprising:
a mobile device adapted to capture context information of a user and using heuristics based on a common knowledge database to turn location tracked over time combined with said context information into semantic location information.

20. The apparatus of claim 19, wherein said mobile device is further adapted to create and identify said heuristics.

21. The apparatus of claim 20, wherein trace data of GPS coordinates are obtained continuously throughout said user's day and first clustered to identify interesting locations, then up-leveled to a street address or business name and then semantically interpreted in one of several categories.

22. The apparatus of claim 21, wherein said heuristics are used to semantically interpret said clustered locations upleveled to a street address or business name, into one of several categories.

23. The apparatus of claim 22, wherein said categories are further refined into a set of daily patterns.

24. The apparatus of claim 19, wherein said mobile device distributes said semantic location information to a service provider and wherein said service provider provides an incentive to said user for said context information.
